(19) United States
(12) Patent Application Publication
(10) Pub. No.: US 2024/0320961 A1
(43) Pub. Date: Sep. 26, 2024

(54) LEARNING MODEL GENERATION DEVICE, LEARNING MODEL GENERATION METHOD AND NON-TRANSITORY COMPUTER-READABLE MEDIUM STORING LEARNING MODEL GENERATION PROGRAM

(71) Applicant: SCREEN HOLDINGS CO., LTD., Kyoto (JP)

(72) Inventors: Yoshinori SHIMADA, Kyoto-shi (JP); Toshiyuki OKAYAMA, Kyoto-shi (JP); Sota CHATANI, Kyoto-shi (JP)

(21) Appl. No.: 18/614,130

(22) Filed: Mar. 22, 2024

(30) Foreign Application Priority Data
Mar. 24, 2023 (JP) 2023-049055

(51) Int. Cl. G06V 10/774; G06V 10/776; G06V 10/778

(52) U.S. Cl. CPC G06V 10/774; G06V 10/776; G06V 10/7788

(57) ABSTRACT

A learning model generation device includes a model information display that displays a plurality of learning models being released on the Internet and having a same interface in a selectable manner, a model selector that displays at least one learning model among the plurality of displayed learning models, and a trainer that subjects the selected learning model to machine learning such that the selected learning model learns training data, and generates a trained model that has been trained.

### BACKGROUND

### Technical Field

The present disclosure relates to a learning model generation device, a learning model generation method and a non-transitory computer readable medium storing a learning model generation program. In particular, the present disclosure relates to a learning model generation device that subjects a learning model to machine learning, a learning model generation method performed by the learning model generation device and a non-transitory computer readable medium storing a learning model generation program for causing a computer to perform the learning model generation method.

### Description of Related Art

In the field of artificial intelligence (AI), a learning model such as a neural network is subjected to machine learning such that the learning model learns a training data set, and a trained learning model is generated. For example, JP 2021-047104 A describes a training device that generates a training data set, and subjects a learning model to machine learning with use of the training data set and causes the learning model to learn the relationship between a substrate image and the presence or absence of a defect to create a trained model. In this manner, in order to generate a trained model, it is necessary to prepare a training data set and a learning model to be subjected to machine learning such that the learning model learns the training data set.

### SUMMARY

Generally, a learning model is constructed based on the algorithm of machine learning, and learns when being provided with a training data set. Therefore, in order to prepare a learning model suitable for estimation by a trained model, it is necessary to code a program for a process in accordance with the algorithm of machine learning. Further, although a trained model can be generated with use of an existing learning model, it is necessary to adapt the existing learning model to a training data set to be learned by the existing learning model. Also in this case, it is necessary to code a program. In this manner, knowledge about a learning model and time for coding a program are required to generate a trained model. Therefore, it is difficult for anyone who has no specialized knowledge to subject a learning model to machine learning, and there is a problem that it takes time to code a program.

An object of the present disclosure is to provide a learning model generation device capable of easily generating a trained learning model.

Another object of the present disclosure is to provide a learning model generation method with which a trained learning model can be easily generated.

Yet another object of the present disclosure is to provide a non-transitory computer readable medium storing a learning model generation program capable of easily generating a trained learning model.
(1) A learning model generation device according to one aspect of the present disclosure includes a model information display that displays a plurality of learning models being released on Internet and having a same interface in a selectable manner, a model selector that displays at least one learning model among the plurality of displayed learning models, and a trainer that subjects the selected learning model to machine learning such that the selected learning model learns training data, and generates a trained model that has been trained.
(2) A learning model generation method according to another aspect of the present disclosure causes a computer to execute a model information display step of displaying a plurality of learning models being released on Internet and having a same interface in a selectable manner, a model selecting step of displaying at least one learning model among the plurality of displayed learning models, and a training step of subjecting the selected learning model to machine learning such that the selected learning model learns training data, and generating a trained model that has been trained.
(3) A non-transitory computer readable medium storing a learning model generation program according to yet another aspect of the present disclosure causes a computer to execute a model information display step of displaying a plurality of learning models being released on Internet and having a same interface in a selectable manner, a model selecting step of displaying at least one learning model among the plurality of displayed learning models, and a training step of subjecting the selected learning model to machine learning such that the selected learning model learns training data, and generating a trained model that has been trained.

A trained learning model can be easily generated.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is a diagram showing one example of the overview of a learning model generation system in the present embodiment;

FIG. 2 is a diagram showing one example of the configurations of the learning model generation device;

FIG. 3 is a diagram showing one example of the functional configurations of the learning model generation device in the present embodiment;

FIG. 4 is a flowchart showing one example of a flow of a learning model generation process;

FIG. 5 is a diagram showing one example of a menu screen;

FIG. 6 is a flowchart showing one example of a flow of a training data generation process;

FIG. 7 is a diagram showing one example of a training data generation screen;

FIG. 8 is a diagram showing one example of a data augmentation setting screen;

FIG. 9 is a diagram showing one example of an image classification setting screen;

FIG. 10 is a diagram showing one example of an object recognition setting screen;

FIG. 11 is a diagram showing one example of an area classification setting screen;

FIG. 12 is a flowchart showing one example of a flow of a learning model acquisition process;

FIG. 13 is a diagram showing one example of a learning model selection screen;

FIG. 14 is a diagram showing one example of an external learning model acquisition screen;

FIG. 15 is a flowchart showing one example of a flow of a machine learning process;

FIG. 16 is a diagram showing one example of a hyperparameter setting screen;

FIG. 17 is a diagram showing one example of a training data selection screen;

FIG. 18 is a flowchart showing one example of a flow of a trained model evaluation process;

FIG. 19 is a diagram showing one example of a trained model evaluation screen;

FIG. 20 is a flowchart showing one example of a flow of a trained model comparison process; and

FIG. 21 is a diagram showing one example of a trained model comparison screen.

### DETAILED DESCRIPTION

A learning model generation system according to one embodiment of the present disclosure will be described below with reference to the drawings. In the following description, the same components are denoted by the same reference numerals. Their names and functions are also the same. Therefore, a detailed description thereof will not be repeated.

### (1) Configuration of Learning Model Generation System

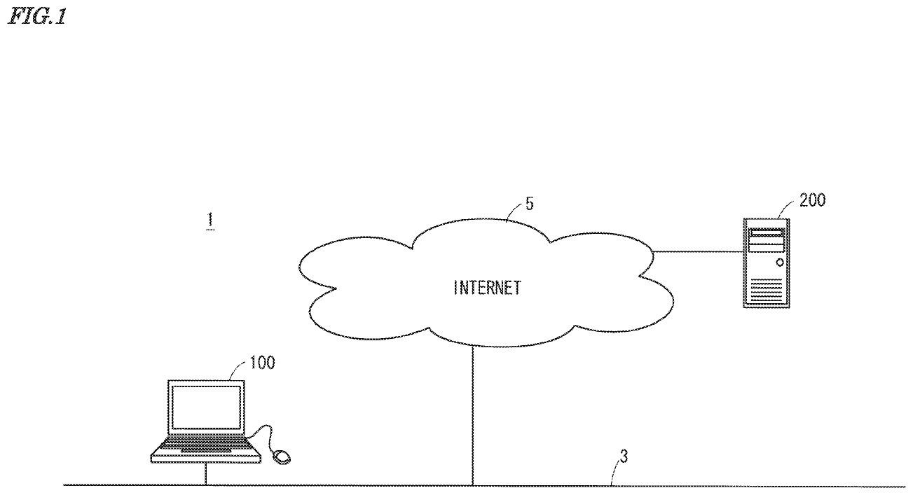

FIG. 1 is a diagram showing one example of the overview of a learning model generation system in the present embodiment. With reference to FIG. 1, the learning model generation system 1 includes a learning model generation device 100 and a server 200. The learning model generation device 100 is a general computer, and is a personal computer (PC), for example.

The learning model generation device is connected to a network 3. The network 3 is a Local Area Network (LAN), either wired or wireless. Further, the network 3 is not limited to a LAN and may be a Wide Area Network (WAN), a Public Switched Telephone Network (PSTN), the Internet or the like.

The network 3 is connected to the Internet 5. The server 200 is connected to the Internet 5. Therefore, the learning model generation device can communicate with the server 200 via the network 3 and the Internet 5. While being connected to the Internet 5 in the present embodiment by way of example, the server 200 may be communicable with the learning model generation device and may be directly connected to the network 3.

The server 200 is a general computer. Because the configuration and functions of the server 200 are well known, a description thereof will not be repeated here. The server 200 stores a plurality of existing learning models and releases the learning models on the Internet 5. A learning model is a deep learning network. The server 200 releases a library area in which the plurality of learning models are stored on the Internet 5. The URL (Uniform Resource Locator) of the library area is released, and anyone can access the library area. The library area is the Python Package Index which is a third party software repository, for example. Here, timm (pytorch-image-models) or Pytorch Hub is used as the library area, by way of example. A learning model stored in timm or Pytorch Hub of the library area is a deep learning network in compliance with a library Pytorch for machine learning written in the programming language Python.

In the present embodiment, the learning model generation system 1 includes one learning model generation device and one server 200, by way of example. However, the number of learning model generation devices and the number of servers 200 are not limited, and the learning model generation system 1 may include one or more learning model generation devices and one or more servers.

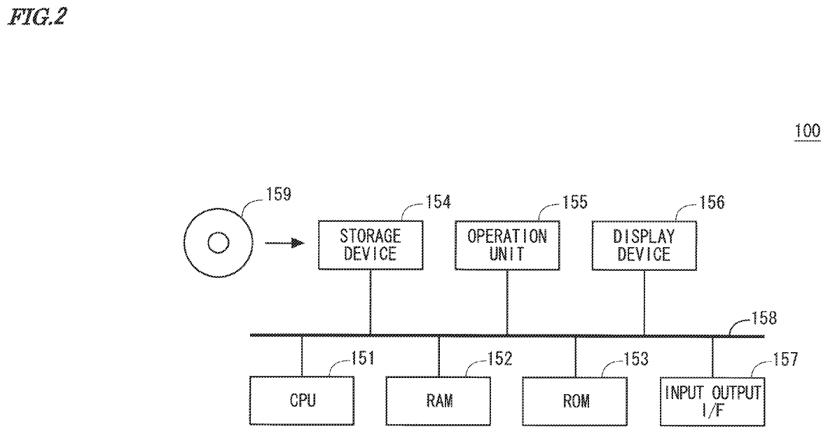

FIG. 2 is a diagram showing one example of the configurations of the learning model generation device. With reference to FIG. 2, the learning model generation device 100 includes a CPU 151, a RAM (Random Access Memory) 152, a ROM (Read Only Memory) 153, a storage device 154, an operation unit 155, a display device 156 and an input output I/F 157. The CPU 151, the RAM 152, the ROM 153, the storage device 154, the operation unit 155, the display device 156 and the input output I/F 157 are connected to a bus 158.

The RAM 152 is used as a work area for the CPU 151. A system program is stored in the ROM 153. The storage device 154 includes a storage medium such as a hard disc or a semiconductor memory and stores various programs and various data. A CD-ROM (Compact Disc-ROM) 159, which is a program readable recording medium, is attachable to and detachable from the storage device 154. The operation unit 155 is an input device such as a keyboard, a mouse or a touch panel. The input output interface (I/F) 157 is connected to the network and connects the CPU 151 to another computer connected to the network. The display device 156 displays various images. In the present embodiment, the display device 156 sequentially displays a plurality of screens for receiving selection of operation contents of the learning model generation device 100.

The CPU 151 loads a program stored in the ROM 153 or the storage device 154 into the RAM 152 and executes the program. The CPU 151 executes a program stored in the ROM 153 or the storage device 154 to control the display device 156 and the operation unit 155, thereby providing a graphical user interface (GUI) to a user.

While the CPU 151 executes a program stored in the storage device 154 by way of example, a program stored in the storage device 154 includes a program downloaded from another computer connected to the network via the network to which the input output I/F 157 is connected. Further, a program stored in the storage device 154 includes a program obtained when another computer connected to the network rewrites the program stored in the storage device 154.

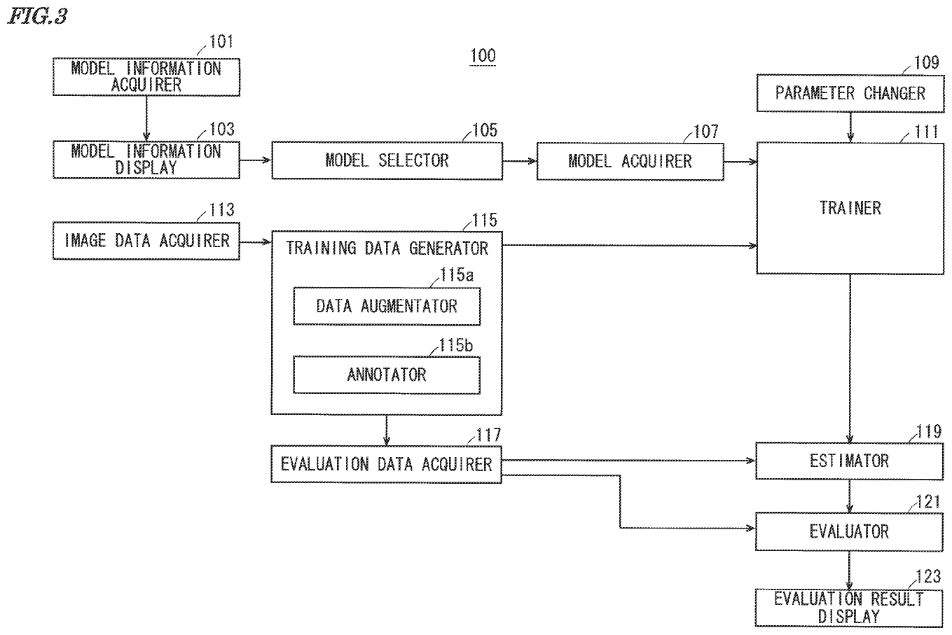

FIG. 3 is a diagram showing one example of the functional configurations of the learning model generation device in the present embodiment. The functions shown in FIG. 3 are implemented by execution of a learning model generation program stored in the ROM 153 or the CD-ROM 159 by the CPU 151 included in the learning model generation device 100.

The learning model generation device 100 includes a model information acquirer 101, a model information display 103, a model selector 105, a model acquirer 107, a parameter changer 109, a trainer 111, an image data acquirer 113, a training data generator 115, an evaluation data acquirer 117, an estimator 119, an evaluator 121 and an evaluation result display 123.

The model information acquirer 101 acquires model information pieces in regard to learning models released on the Internet. Here, one or more network addresses indicating the respective positions on the Internet of one or more library areas released on the Internet 5 are stored in advance in the storage device 154. The one or more library areas released on the Internet 5 include a library area included in the server 200, for example.

In each of the one or more library areas, a model information piece is stored in regard to each of one or more learning models stored in the library area. Model information includes model identification information for identifying a learning model and explanatory information in regard to the learning model.

The model information acquirer 101 displays the URL of the one or more library areas stored in the storage device 154 on the display device 156, and selects the URL of a library area in accordance with an operation input to the operation unit 155 by the user. In response to selection of one URL from among one or more URLs displayed on the display device 156 in accordance with a user operation, the model information acquirer 101 controls the input output I/F 157 to access the URL selected in accordance with the user operation. The model information acquirer 101 acquires model identification information pieces of one or more learning models stored in the library area specified by the URL, and displays the model identification information pieces on the display device 156. Then, in a case in which a model identification information piece displayed on the display device 156 is designated by the user, the model information acquirer 101 downloads the model information piece of a learning model corresponding to the designated model identification information piece. The model information acquirer 101 outputs the downloaded model information piece to the model information display 103. Model information may be stored in an area different from the library area. For example, model information may be stored in a computer different from the server 300.

The model information display 103 displays one or more model information pieces received from the model information acquirer 101 on the display device 156. Specifically, the model information display 103 generates a model list screen in which one or more model identification information pieces respectively included in one or more model information pieces are arranged, and displays the model list screen on the display device 156. The model list screen is a screen that displays one or more model identification information pieces in a selectable manner.

Further, the model information display 103 generates an explanatory screen based on an explanatory information piece included in a model information piece and displays the explanatory screen on the display device 156. The model information acquirer 101 determines one of one or more model identification information pieces included in the model list screen displayed on the display device 156 in accordance with an operation input to the operation unit 155 by the user. In response to determination of one model identification information piece in accordance with a user operation, the model information acquirer 101 generates an explanatory screen and displays the explanatory screen on the display device 156. The explanatory screen includes an explanatory information piece associated with the model identification information piece by a model information piece. The user who views the explanatory screen can confirm the characteristics of a learning model such as the characteristics of algorithm of the learning model specified by the model identification information piece selected on the model list screen. Therefore, it is possible to provide information that assists selection of a subject learning model from among one or more learning models respectively specified by the one or more model identification information pieces included in the model list screen.

The model selector 105 determines one of the one or more learning models specified by the one or more model identification information pieces included in the model list screen displayed on the display device 156 as a training subject. The model selector 105 determines a training subject in accordance with an operation input to the operation unit 155 by the user. The model selector 105 outputs the model identification information piece of the learning model determined as a training subject to the model acquirer 107.

The model acquirer 107 acquires the learning model in response to receiving the model identification information piece from the model selector 105. The model acquirer 107 controls the input output I/F 157 to access the URL of the library area in which the learning model of the model identification information piece received from the model selector 105 is stored, and downloads the learning model specified by the model identification information received from the model selector 105. The model acquirer 107 outputs the downloaded learning model to the trainer 111.

The image data acquirer 113 acquires a plurality of image data pieces. The image data pieces acquired by the image data acquirer 113 are image data pieces to be used for subjecting the learning model acquired by the model acquirer 107 to machine learning. The image data pieces may be image data pieces stored in advance in the storage device 154 or may be image data pieces stored in another recording medium such as a CD-ROM. Further, the image data pieces may be data pieces released on the Internet 5. In this case, the image data acquirer 113 controls the input output I/F 157 to download image data pieces released on the Internet 5. The image data acquirer 113 outputs the plurality of acquired image data pieces to the training data generator 115.

The training data generator 115 receives the plurality of image data pieces from the image data acquirer 113. The training data generator 115 generates one or more training data pieces based on the image data pieces. The training data generator 115 outputs a plurality of training data pieces which are part of the plurality of training data pieces generated based on the plurality of image data pieces to the trainer 111, and outputs another part of the plurality of training data pieces to the evaluation data acquirer 117. The training data generator 115 includes a data augmentor 115a and an annotator 115b.

The data augmentor 115a executes an augmentation process in accordance with an operation input to the operation unit 155 by the user. The augmentation process is a process executed on an image data piece, and includes a size-enlargement process, a size-reduction process, an inversion process, a rotation process, a horizontal movement process, a blackening process and a homography conversion process. By executing the augmentation process on one image data piece, the data augmentor 115a generates one or more different image data pieces. The one or more different image data pieces generated by the data augmentor 115a are treated similarly to the image data piece that has been subjected to the augmentation process. In other words, the one or more different image data pieces generated by the data augmentor 115a are part of the training data pieces.

The size-enlargement process is a process of generating an image data piece that is obtained when the size of an object included in an image data piece is enlarged. The size-reduction process is a process of generating an image data piece obtained when the size of an object included in an image data piece is reduced. The inversion process is a process of generating an image data piece obtained when the direction of an object included in an image data piece is inverted. The direction of the object includes a vertical direction and a horizontal direction. The rotation process is a process of generating an image data piece obtained when an object included in an image data piece is rotated. A rotation angle includes a predetermined angle or an angle designated by the user. The horizontal movement process is a process of generating an image data piece obtained when an object included in an image data piece is moved horizontally. The number of pixels and a direction of the parallel movement include a predetermined number of pixels and a predetermined direction, and the number of pixels and a direction designated by the user. The blackening process is a process of generating an image data piece obtained when pixel values of unnecessary portions other than an object in an image data piece are converted into a value indicating black. The homography conversion process is a processing of generating an image data piece obtained when an object included in an image data piece is converted into another object with use of a homography matrix. The homography conversion process is a process of converting an object included in an image data piece before conversion into a shape obtained when the image of the object is picked up as a subject from a position different from a position at which the image of the object included in the image data piece before conversion is picked up as a subject. The data augmentor 115a stores an image data piece on which the augmentation process has been executed in the storage device 154 as a new image data piece different from an original image data piece.

The annotator 115b performs an annotation process on an image data piece in accordance with an operation input to the operation unit 155 by the user. An image data piece to be processed by the annotator 115b includes a plurality of images data pieces received from the image data acquirer 113 and a plurality of image data pieces generated by the data augmentor 115a.

The annotation process is a process of adding metadata to an image data piece. Here, metadata includes image type information and label information. Image type information includes image classification representing the type of an image data piece and representing an image itself, object recognition representing a rectangular area including an object, and segmentation representing the outline of an object.

The annotator 115b displays an image of an image data piece selected by the user on the display device 156 in accordance with an operation input to the operation unit 155 by the user. The annotator 115b receives an image type information piece input to the operation unit 155 by the user, and adds the received image type information piece to an image data piece. Further, the annotator 115b receives a label information piece input to the operation unit 155 by the user, and adds the received label information piece to an image data piece. Label information is an objective variable in supervised learning. For example, in a case in which a learning model is trained to learn a process of identifying an object included in an image data piece, a label information piece is an information piece for identifying the object. More specifically, in a case in which an object is either a dog or a cat, a label information piece is a value indicating either a dog or a cat.

In a case in which receiving a value of object recognition as an image type information piece, the annotator 115b adds an object recognition information piece to an image displayed on the display device 156 in accordance with an operation input to the operation unit 155 by the user. The operation input to the operation unit 155 by the user is an operation of specifying a rectangular area in the image displayed on the display device 156. The operation of specifying a rectangular area is an operation of designating the coordinates of two opposite corners of the rectangular area, for example. The annotator 115b adds an information piece representing the rectangular area designated by the user in the image displayed on the display device 156 as the object recognition information piece.

In a case in which receiving a value of segmentation as an image type information piece, the annotator 115b adds a segmentation information piece to an image displayed on the display device 156 in accordance with an operation input to the operation unit 155 by the user. The operation input to the operation unit 155 by the user is an operation of specifying the outline of an object in the image displayed on the display device 156. The operation of specifying the outline of an object is an operation of designating a plurality of successive coordinates of the outline of the object, for example. The annotator 115b adds an information piece representing the area surrounded by the outline obtained when two adjacent coordinates are connected based on the plurality of coordinates designated by the user in the image displayed on the display device 156 as an object recognition information piece.

In a case in which receiving a value of image classification as an image type information piece, the annotator 115b adds the image classification information piece to an image displayed on the model information display 103. Image classification information is information representing neither object recognition information nor segmentation information. In a case in which receiving a value of image classification as an image type information piece, the annotator 115b adds an image classification information piece to an image data piece.

The parameter changer 109 sets a hyperparameter in accordance with an operation input to the operation unit 155 by the user. A hyperparameter is a value used to control the behavior of various algorithms defined by a learning model. Here, a hyperparameter includes a training count, a patch size, an optimization function and a learning rate. A hyperparameter may further include the number of layers of a neural network, the number of neurons per layer, a kernel size and the like. The parameter changer 109 outputs a hyperparameter set by the user to the trainer 111.

The trainer 111 receives a learning model from the model acquirer 107, receives a hyperparameter from the parameter changer 109 and receives a plurality of training data pieces from the training data generator 115. The trainer 111 subjects the learning model to machine learning and causes the learning model to learn the plurality of training data pieces in accordance with the hyperparameter. Specifically, the trainer 111 sets the hyperparameter in the learning model, and subjects the learning model to machine learning such that the learning model learns the plurality of training data pieces in accordance with the hyperparameter. The trainer 111 provides an image data piece included in the training data pieces to the learning model as an input data piece, and subjects the learning model to machine learning such that the learning model learns a value of a label information piece included in the training data pieces as a correct data piece. Machine learning is a process of optimizing a weight coefficient of a neural network including a learning model using a method such as a back-propagation method such that an error from a correct data piece is minimized, for example.

Here, a unit of a process of subjecting a learning model to machine learning such that the learning model learns a plurality of training data pieces is referred to as an epoch. A training count included in the hyperparameter indicates an upper limit value of the number of times an epoch is to be repeated. The trainer 111 repeats a process of subjecting the learning model to machine learning such that the learning model learns the plurality of training data pieces by a training count defined by the hyperparameter. Each time one epoch ends, the trainer 111 outputs a trained learning model at that point in time to the estimator 119. Therefore, the trained learning model is specified by the number of times an epoch is repeated. In other words, the trainer 111 outputs a plurality of trained learning models having different epoch repetition counts to the estimator 119. Hereinafter, a trained learning model the epoch repetition count of which is N (N is a positive integer) is referred to as a trained model having the epoch repetition count N.

The evaluation data acquirer 117 receives a plurality of training data pieces from the training data generator 115. The plurality of training data pieces received by the evaluation data acquirer 117 are different from the plurality of training data pieces received by the trainer 111. The evaluation data acquirer 117 outputs the plurality of training data pieces received from the training data generator 115 as evaluation data pieces to the estimator 119 and the evaluator 121.

The estimator 119 receives the plurality of trained models having different epoch repetition counts from the trainer 111 and receives the plurality of evaluation data pieces from the evaluation data acquirer 117. The estimator 119 provides an evaluation data piece to a trained model to acquire an estimated value estimated by the trained model. The estimator 119 acquires one estimated value with respect to one evaluation data piece. Therefore, the estimator 119 acquires a plurality of estimated values respectively corresponding to the plurality of evaluation data pieces.

Further, in regard to each of the plurality of trained models having different epoch repetition counts, the estimator 119 provides an evaluation data piece to a trained model to acquire an estimated value estimated by the trained model. Therefore, the estimator 119 acquires a plurality of estimated values in regard to a trained model having the epoch repetition count N. The estimator 119 outputs the plurality of estimated values to the evaluator 121 for each epoch repetition count. In other words, the estimator 119 outputs a set of the epoch repetition count N and a plurality of estimated values to the evaluator 121.

The number of sets of the epoch repetition count N and a plurality of estimated values received by the evaluator 121 from the estimator 119 corresponds to the number of times an epoch is repeated, and the evaluator 121 receives the plurality of evaluation data pieces from the evaluation data acquirer 117. The evaluator 121 evaluates a trained model for each epoch repetition count. Here, evaluation of a trained model having the epoch repetition count N will be described. The evaluator 121 compares a guess value corresponding to the trained model having the epoch repetition count N with a value of a label information piece (correct data piece) included in an evaluation data piece received from the evaluation data acquirer 117. A guess value is a value estimated by a trained model based on an evaluation data piece. Therefore, one guess value corresponds to one evaluation data piece. The evaluator 121 determines that a guess value is correct when the guess value is the same as a value of a label information piece, and determines that a guess value is incorrect when a guess value is different from a value of a label information piece. The evaluator 121 compares each of a plurality of evaluation data pieces with an estimated value corresponding to the evaluation data piece, and generates an evaluation index as a performance data piece by executing a statistical process. Performance data includes accuracy, recall and precision as evaluation indices. The evaluation index indicating accuracy is a value obtained when the number of correct data pieces by the total number of estimations, and is expressed by the following formula (1). The evaluation index indicating recall is a value obtained when the number of correct data pieces by the total number of correct data pieces, and is expressed by the following formula (2). The evaluation index indicating precision is expressed by the following formula (3).

$$Accuracy = ( TP + TN ) / ( TP + TN + FP + FN ) \qquad ( 1 )$$

$$Recall = TP / ( TP + FN ) \qquad ( 2 )$$

$$Precision = TP / ( TP + FP ) \qquad ( 3 )$$

However, TP (True Positive) is the number of correct estimations of correct data pieces, TN (True Negative) is the number of correct estimation of incorrect data pieces, FP (False Positive) is the number of incorrect estimations of incorrect data pieces, and FN (False Negative) is the number of incorrect estimations of correct data pieces.

Here, the evaluator 121 calculates a performance data piece with respect to the trained model having the epoch repetition count N. The evaluator 121 outputs a performance data piece with respect to the trained model having the epoch repetition count N to the evaluation result display 124.

The evaluation result display 123 receives the performance data piece in regard to the trained model having the epoch repetition count N with respect to each of a plurality of trained models having different epoch repetition counts. In regard to each of the plurality of learning models having the different epoch repetition counts, the evaluation result display 123 generates an evaluation result screen for displaying performance data pieces and displays the generated evaluation result screen on the display device 156.

In a case in which a plurality of trained models are generated by the trainer 111, the evaluation result display 123 generates a model comparison screen for comparing the plurality of trained models, and displays the generated model comparison screen on the display device 156.

### (2) Flow of Series of Operations of Learning Model Generation Device

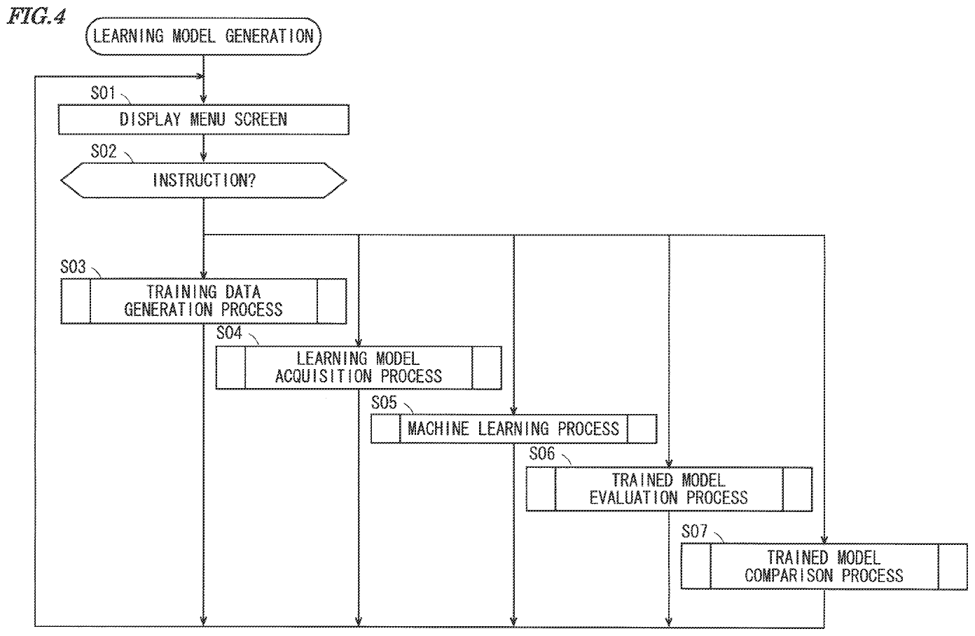

FIG. 4 is a flowchart showing one example of a flow of a learning model generation process. The learning model generation process is a process executed by the CPU 151 when the CPU 151 included in the learning model generation device 100 executes the learning model generation program stored in the RAM 152 or the CD-ROM by the CPU 151 included in the learning model generation device 100. With reference to FIG. 4, the CPU 151 included in the learning model generation device 100 displays a menu screen stored in the storage device 154, and the process proceeds to the step S02 (step S01).

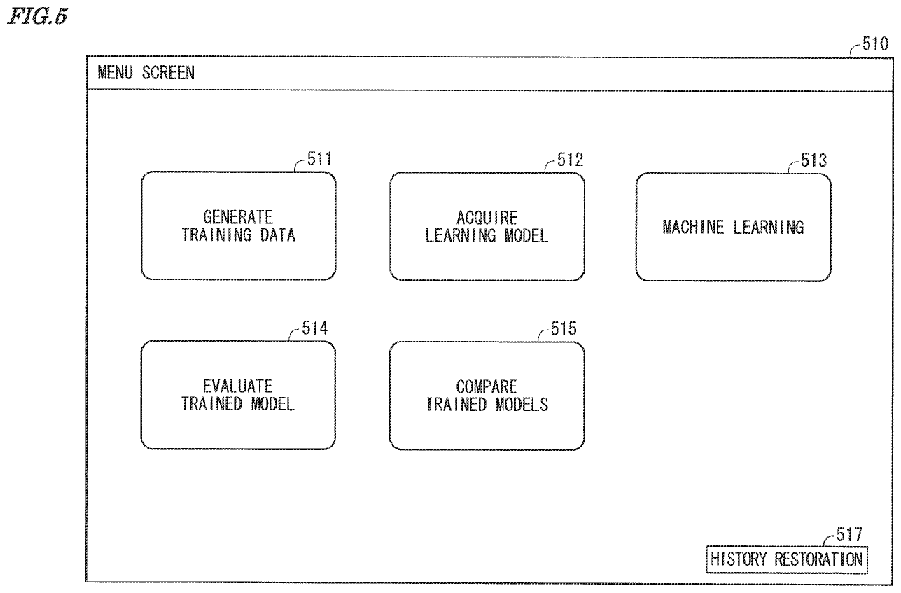

FIG. 5 is a diagram showing one example of a menu screen. With reference to FIG. 5, the menu screen 510 includes buttons 511 to 515. The buttons 511 to 515 are buttons for receiving instructions from the user. With the menu screen displayed on the display device 156, the CPU 151 receives an instruction from the user based on an operation input to the operation unit 155 by the user. The CPU 151 receives a training data generation instruction in a case in which receiving an operation of designating the button 511 from the user, receives a learning model acquisition instruction in a case in which receiving an operation of designating the button 512 from the user, receives a machine learning instruction in a case in which receiving an operation of designating the button 513 from the user, receives a trained model evaluation instruction in a case in which receiving an operation of designating the button 514 from the user, and receives a trained model comparison instruction in a case in which receiving an operation of designating the button 515 from the user.

The menu screen 510 further includes a button 517 in which a character string “HISTORY RESTORATION” is displayed. When the button 517 is designated by the user, the CPU 151 restores an operation that was input when the user selected a training data piece in the past. Thus, the user can easily restore a past instruction.

Returning to FIG. 4, in the step S02, the CPU 151 branches a process in response to an instruction from the user. In a case in which the training data generation instruction is received, the process proceeds to the step S03. In a case in which the learning model acquisition instruction is received, the process proceeds to the step S04. In a case in which the machine learning instruction is received, the process proceeds to the step S05. In a case in which the trained model evaluation instruction is received, the process proceeds to the step S06. In a case in which the learning model comparison instruction is received, the process proceeds to the step S07. In the step S03, a training data generation process is executed, and the process returns to the step S01. In the step S04, a learning model acquisition process is executed, and the process returns to the step S01. In the step S05, a machine learning process is executed, and the process returns to the step S01. In the step S06, a trained model evaluation process is executed, and the process returns to the step S01. In the step S07, a trained model comparison process is executed, and the process returns to the step S01. Details of the training data generation process, the learning model acquisition process, the machine learning process, the trained model evaluation process and the trained model comparison process will be described below.

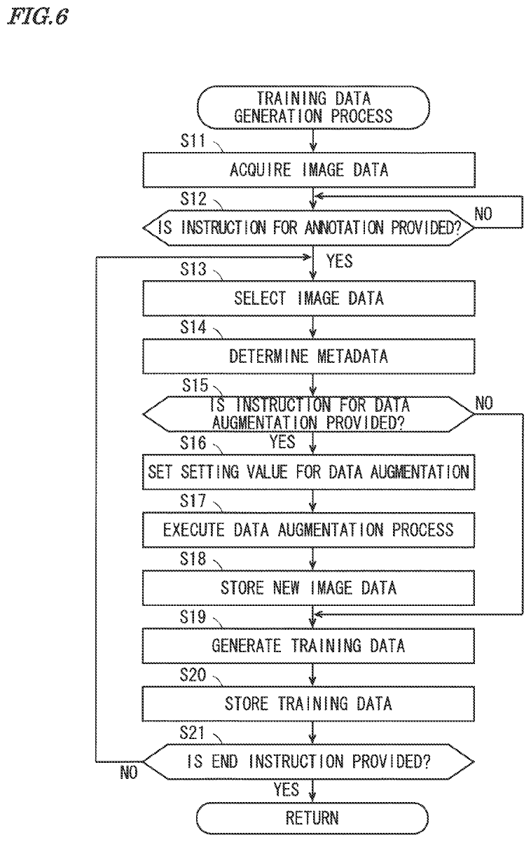

FIG. 6 is a flowchart showing one example of a flow of a training data generation process. The training data generation process is a process executed by the CPU 151 in the step S03 of the learning model generation process.

With reference to FIG. 6, the CPU 151 acquires an image data piece (step S11), and the process proceeds to the step S12. The image data piece is a data piece that is used to subject a learning model, which is subjected to machine learning to be executed in the below-mentioned machine learning process, to machine learning. The image data piece is an image data piece stored in advance in the storage device 154 or an image data piece stored in another recording medium such as a CD-ROM. Further, the image data piece may be a data piece released on the Internet 5. In this case, the CPU 151 controls the input output I/F 157 to download the image data piece released on the Internet 5. The CPU 151 provides a data name for identifying the image data piece to the image data piece and stores the image data piece in the storage device 154. Further, the CPU 151 stores a group of a plurality of image data pieces as one data group in the storage device 154. The image data pieces are associated with a data group name for identifying the data group to which the image data pieces belong.

In the step S12, whether an annotation instruction is provided is determined. In a case in which the operation unit 155 receives an operation of providing an instruction for executing the annotation process, the CPU 151 determines that an annotation instruction is provided. If an annotation instruction is provided, the process proceeds to the step S13. If not, the process waits. In the step S13, an image data piece to be processed is selected, and the process proceeds to the step S14. One image data piece to be processed is selected from among a plurality of image data pieces stored in the storage device 154. The image data piece is selected by the user when the user operates the operation unit 155.

In the step S14, metadata is determined, and the process proceeds to the step S15. While details of a process of determining metadata will be described below, the metadata includes a label information piece (correct data piece).

In the step S15, whether an instruction for data augmentation is provided is determined. In a case in which the operation unit 155 receives an operation of providing an instruction for executing the augmentation process, the CPU 151 determines that an instruction for data augmentation is provided. If an instruction for data augmentation is provided, the process proceeds to the step S16. If not, the process proceeds to the step S19. In the step S16, a setting value used for the data augmentation process is set, and the process proceeds to the step S17. In the step S17, the data augmentation process is executed, and the process proceeds to the step S18. The data augmentation process, which will be described below in detail, is a process of generating one or more new different image data pieces based on one image data piece. In the step S18, the generated new image data piece is stored in the storage device 154.

In the step S19, a training data piece is generated, and the process proceeds to the step S20. In a case in which the step S19 is performed after the step S15, the training data piece generated in the step S19 is a data piece generated when the image data piece selected in the step S13 is associated with the metadata determined in the step S14. In a case in which the step S19 is performed after the step S18, the training data piece generated in the step S19 includes a data piece generated when the image data piece generated in the step S17 is associated with the metadata determined in the step S14 in addition to a data piece obtained when the image data piece selected in the step S13 is associated with the metadata determined in the step S14. In other words, a training data piece including the image data piece selected in the step S13 and one or more training data pieces respectively including the one or more image data pieces that are augmented in the step S17 are generated. In the step S20, the training data pieces are stored in the storage device 154, and the process proceeds to the step S21.

In the step S21, whether an end instruction is provided is determined. In a case in which the operation unit 155 receives an operation of providing an instruction for ending a process, the CPU 151 determines that an end instruction is received. If the end instruction is received, the process returns to the learning model generation process. If not, the process returns to the step S13.

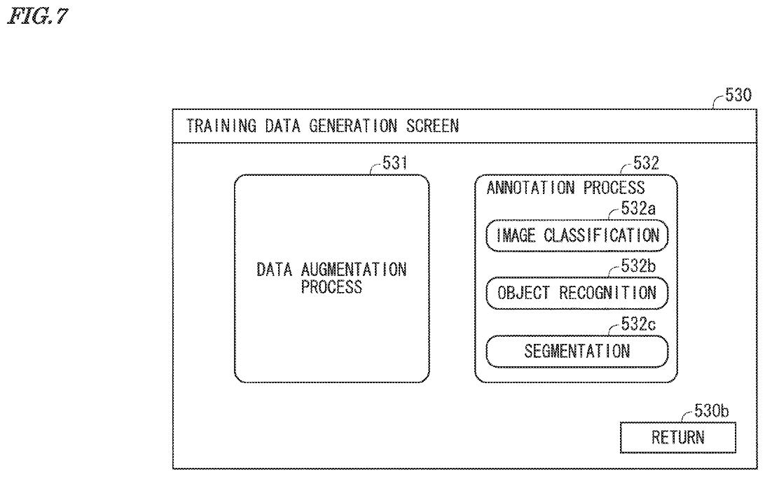

FIG. 7 is a diagram showing one example of a training data generation screen. With reference to FIG. 7, the training data generation screen 530 includes a button 531 on which the character string for the data augmentation process is displayed and a button 532 on which the character string for the annotation process is displayed. The button 532 includes a button 532a on which the character string for image classification is displayed, a button 532b on which the character string for object recognition and a button 532c on which the character string for segmentation is displayed. The button 531 is a button for receiving a data augmentation instruction, and the buttons 532a, 532b, 532c are buttons for receiving an annotation instruction.

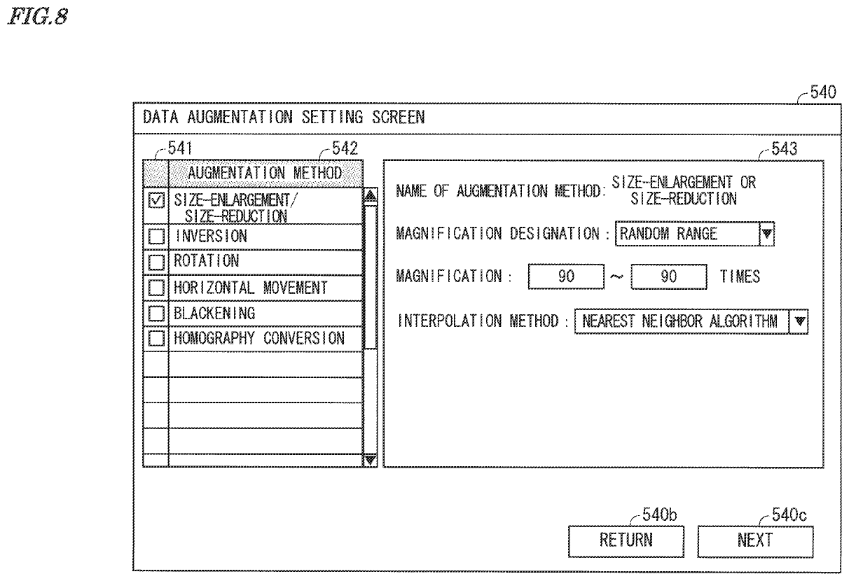

FIG. 8 is a diagram showing one example of a data augmentation setting screen. The data augmentation setting screen 540 of FIG. 8 is a screen displayed on the display device 156 in response to designation of the button 531 of the training data generation screen 530 by the user. Further, the data augmentation setting screen 540 is a screen displayed on the display device 156 when the user sets a setting value used for executing the data augmentation process. With reference to FIG. 8, the data augmentation setting screen 540 includes an area 542 in which the types of setting values to be set are displayed and an area 543 in which setting values for setting items are displayed. In the area 542, size-enlargement or size-reduction, inversion, rotation, horizontal movement, blackening and homography conversion are displayed as the types in a selectable manner. A check box is provided at the left of each type. When the user selects one of the plurality of types, a mark indicating that the type is selected as a process subject is displayed in the check box at the left of the type. Here, it is shown that the size-enlargement and size-reduction is selected as a process subject.

The size-enlargement or size-reduction as a type indicates the size-enlargement process or the size-reduction process of generating an image data piece obtained when the size of an object included in an image data piece is enlarged or reduced. The inversion as a type indicates the inversion process of generating an image data piece obtained when the direction of an object included in an image data piece is inverted. The rotation process as the type indicates the rotation process of generating an image data piece obtained when an object included in an image data piece is rotated. The horizontal movement as a type indicates the horizontal movement process of generating an image data piece obtained when an object included in an image data piece is moved horizontally. The blackening as a type indicates the blackening process of generating an image data piece obtained when the pixel values of unnecessary portions other than an object are converted to a value indicating black. The homography conversion as a type indicates the homography conversion process of generating an image data piece obtained when an object included in an image data piece is converted into another object with use of a homography matrix.

In the area 543, the setting values to be set for one or more setting items belonging to the type selected as a process subject in the area 542 are displayed. When the type is selected in the area 542, default setting values defined in advance are set for one or more setting items belonging to the type, and default values are displayed. The user can change the setting values displayed in the area 543 by operating the operation unit 155.

The data augmentation setting screen 540 further includes a button 540b on which the character string “RETURN” is displayed and a button 540c on which the character string “NEXT” is displayed. In a case in which the button 540b is designated by the user, the training data generation screen 530 shown in FIG. 7 is displayed on the display device. In a case in which the button 540c is designated by the user, the data augmentation process is executed with respect to an image data piece set as a process subject. The image data piece set as a process subject is an image data piece stored in the storage device 154, and is an image data piece designated by the user or a plurality of image data pieces belonging to a data group designated by the user.

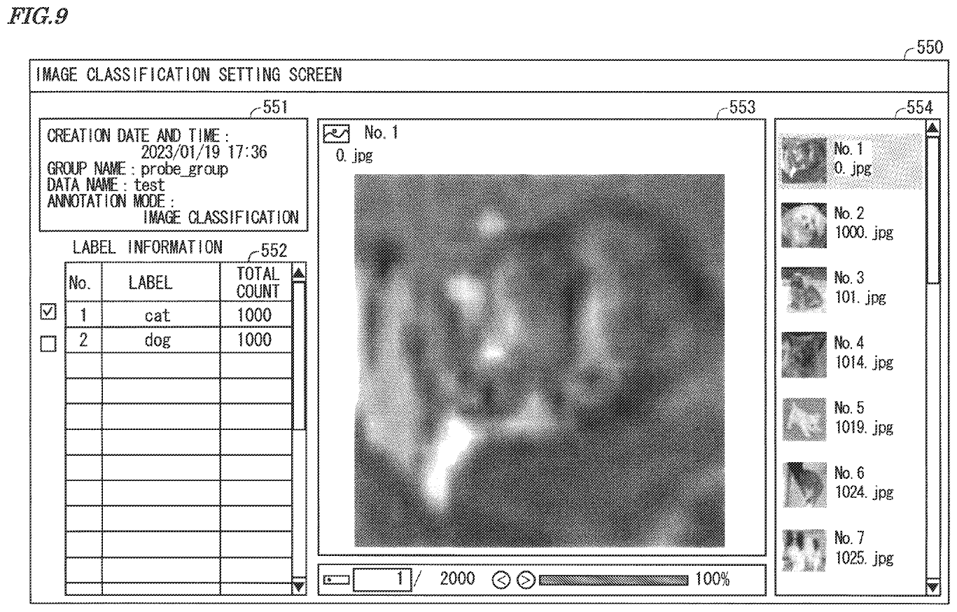

FIG. 9 is a diagram showing one example of an image classification setting screen. The image classification setting screen is a screen displayed on the display device 156 when the user sets an image classification tag in an image data piece. The image classification setting screen is a screen displayed on the display device 156 in response to designation of the button 532a of the training data generation screen 530 by the user. With reference to FIG. 9, the image classification setting screen 550 includes an area 551 in which an annotation mode is displayed, an area 552 in which label information pieces are displayed, an area 553 in which an image of an image data piece is displayed and an area 554 in which a list of image data pieces is displayed.

In the area 554, a list of a plurality of image data pieces belonging to a data group designated by the user as a process subject is displayed. In the area 554, a thumbnail which is an image obtained when the size of an image data piece is reduced, and a file name for identifying the image data piece are displayed side by side. Further, in the area 554, the thumbnail and the file name of an image data piece designated as a process subject by the user are highlighted and displayed so as to be distinguished from other images. When the user designates any of a plurality of thumbnails displayed in the area 554, the image data piece corresponding to a designated thumbnail is selected as a process subject.

In the area 553, an image of an image data piece to be processed is displayed. In the area 551, it is indicated that the image type information piece represents image classification. In the area 552, “cat” and “dog” are displayed as label information pieces in an exclusively selectable manner. A check box is arranged at the left of a label information piece, and the user can designate either “cat” or “dog” for the label information piece.

The user sets the label information piece using the image classification setting screen 550, so that metadata in which the image type information piece represents image classification and metadata in which the label information piece represents “cat” are generated for the image data piece having the file name ‘0.jpg.’

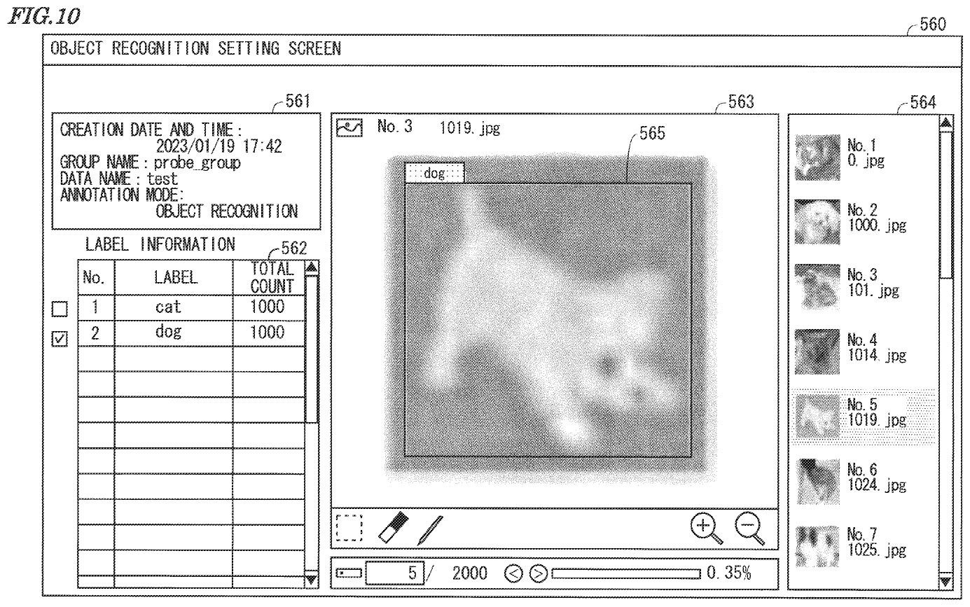

FIG. 10 is a diagram showing one example of an object recognition setting screen. The object recognition setting screen is a screen displayed on the display device 156 when the user sets an object recognition tag in an image data piece. The object recognition setting screen is a screen displayed on the display device 156 in response to designation of the button 532b of the training data generation screen 530 by the user. With reference to FIG. 10, the object recognition setting screen 560 includes an area 561 in which an annotation mode is displayed, an area 562 in which label information pieces are displayed, an area 563 in which an image of an image data piece is displayed and an area 564 in which a list of image data pieces is displayed.

In the area 564, a list of a plurality of image data pieces belonging to a data group designated by the user as a process subject is displayed. In the area 564, a thumbnail which is an image obtained when the size of an image data piece is reduced and a file name for identifying an image data piece are arranged side by side. Further, in the area 564, the thumbnail and the file name of an image data piece designated as a process subject by the user are highlighted and displayed so as to be distinguished from other images. When the user designates any of a plurality of thumbnails displayed in the area 564, the image data piece corresponding to the designated thumbnail is selected as a process subject.

In the area 563, an image of the image data piece to be processed is displayed. Further, a rectangular area 565 surrounding an object in the image data piece is displayed. The user designates the coordinates of two diagonal vertices of a rectangle, so that the area 565 is defined and displayed.

In the area 561, it is indicated that the image type information piece represents object recognition. In the area 562, “cat” and “dog” are displayed as the label information pieces in an exclusively selectable manner. A check box is arranged at the left of a label information piece, and the user can designate either “cat” or “dog” for the label information piece.

When the user sets a label information piece using the object recognition setting screen 560, metadata in which the image type information piece represents object recognition, metadata representing the position of the rectangular area 565 surrounding an object in the image and metadata in which the label information piece represents “dog” are generated with respect to an image data piece having the file name ‘1019.jpg.’

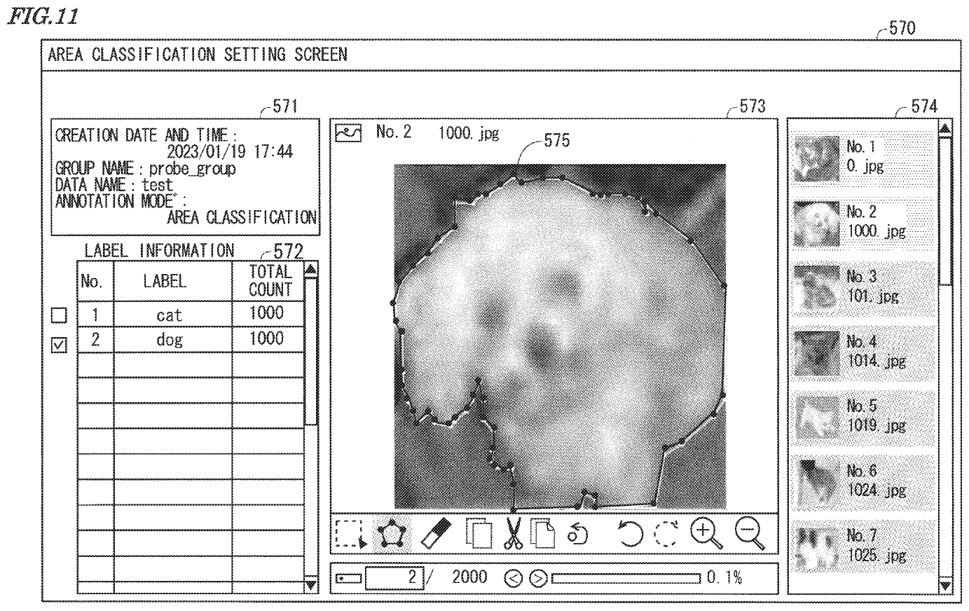

FIG. 11 is a diagram showing one example of an area classification setting screen. The area classification setting screen is a screen displayed on the display device 156 when the user sets metadata for object recognition in an image data piece. The area classification setting screen is a screen displayed on the display device 156 in response to designation of the button 532c of the training data generation screen 530 by the user. With reference to FIG. 11, the area classification setting screen 570 includes an area 571 in which an annotation mode is displayed, an area 572 in which label information pieces are displayed, an area 573 in which an image of an image data piece is displayed and an area 574 in which a list of image data pieces is displayed.

In the area 574, a list of a plurality of image data pieces belonging to a data group designated by the user as a process subject is displayed. In the area 574, a thumbnail which is an image obtained when the size of an image data piece is reduced and a file name for identifying an image data piece are arranged side by side. Further, in the area 574, the thumbnail and the file name of an image data piece designated as a process subject by the user are highlighted and displayed so as to be distinguished from other images. When the user designates any of a plurality of thumbnails displayed in the area 574, the image data piece corresponding to the designated thumbnail is selected as a process subject.

In the area 573, an image of an image data piece to be processed is displayed. Further, in the image data piece, an outline 575 of an object is displayed. The user designates a plurality of coordinates corresponding to the positions in the vicinity of the line forming the outline of the object, so that the outline 575 connecting two adjacent coordinates among the plurality of coordinates is defined and displayed.

In the area 571, it is indicated that the image type information piece represents area classification. In the area 572, “cat” and “dog” are displayed as the label information pieces in an exclusively selectable manner. A check box is arranged at the left of a label information piece, and the user can designate either “cat” or “dog” for the label information piece.

When the user sets a label information piece using the area classification setting screen 570 and sets the outline 575, metadata in which the image type information piece represents object recognition, metadata representing the position of the outline 575 of the object in the image and metadata in which the label information piece represents “dog” are generated with respect to an image file having the file name ‘1000.jpg.’

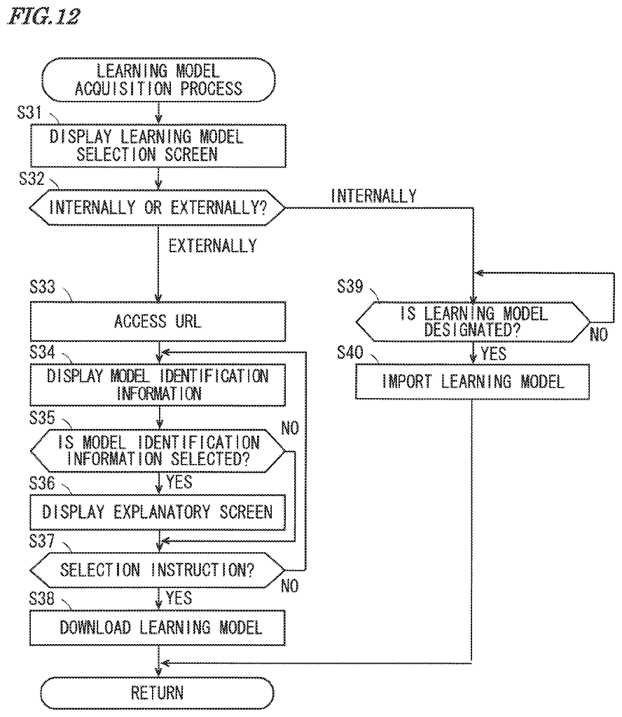

FIG. 12 is a flowchart showing one example of a flow of a learning model acquisition process. The learning model acquisition process is a process executed in the step S04 of the learning model generation process. With reference to FIG. 12, the CPU 151 displays a learning model selection screen on the display device 156 (step S31), and the process proceeds to the step S32.

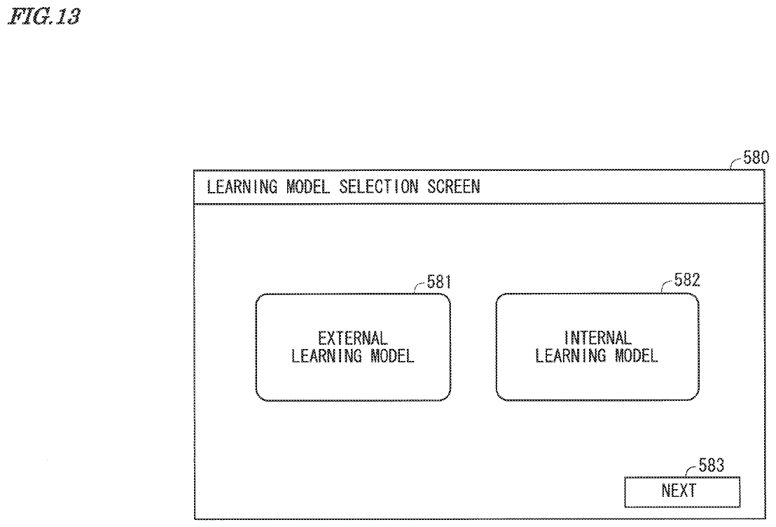

FIG. 13 is a diagram showing one example of a learning model selection screen. With reference to FIG. 13, the learning model selection screen 580 includes buttons 581 to 583. The button 581 is a button for receiving an instruction for selecting a learning model released on the Internet. The button 582 is a button for receiving an instruction for selecting a learning model stored in the storage device 154. The button 583 is a button for receiving an instruction for ending the learning model selection screen.

Returning to FIG. 12, the CPU 151 branches a process by receiving an instruction indicating whether a learning model is to be acquired internally or externally (step S32). In a case in which receiving an operation of designating the button 581 in the learning model selection screen, the CPU 151 receives an instruction for acquiring a learning model externally, and the process proceeds to the step S33. In a case in which receiving an operation of designating the button 582 in the learning model selection screen, the CPU 151 receives an instruction for acquiring a learning model internally, and the process proceeds to the step S39.

In the step S33, the CPU 151 accesses a URL, and the process proceeds to the step S34. A URL is a network addresses indicating a position on the Internet of a library area released on the Internet 5. A library area is an area for storing a plurality of learning models having a unified interface. Here, an interface is a generic term for effects of the shape and function of each of input and output of a learning model. Specifically, when a learning model has an interface, it means that the learning model receives a combination of one or more numeric strings for each of input and output, the learning model has one or more functions of processing the numeric strings, and the learning model clarifies a method of designating the form and the function of each of input and output. In other words, two or more learning models having the same interface have the same input and output formats, and the two or more learning models have the same type of function and the same method of designating the function. A learning model is a deep learning network. Here, timm (pytorch-image-models) or Pytorch Hub is used as a library area. A URL may be stored in the storage device 154 in advance, or may be received when the user inputs the URL to the operation unit 155.

In the step S34, a model identification information piece of each of one or more learning models stored in a library area is displayed, and the process proceeds to the step S35. A list of one or more model identification information pieces are displayed on the display device 156 in a selectable manner. In the step S35, whether one model identification information piece is selected from among the one or more model identification information pieces is determined. If a model identification information piece is selected, the process proceeds to the step S36. If not, the process proceeds to the step S37. In the step S36, an explanatory screen is displayed on the display device 156, and the process proceeds to the step S03. An explanatory screen includes an area in which explanatory information in regard to the learning model corresponding to the model identification information piece selected in the step S35 is displayed. Explanatory information includes an information piece representing detailed contents of a learning model, such as characteristics of the learning model. Therefore, because the explanatory information is presented to the user who determines whether a learning model is to be subjected to machine learning, determination of the user can be assisted.

In the step S37, whether a selection instruction is received is determined. If a selection instruction is received, the process proceeds to the step S38. If not, the process returns to the step S34. In the step S39, the learning model corresponding to the model identification information piece selected in the step S36 is downloaded, and the process returns to the learning model generation process.

In the step S39, whether a learning model is designated is determined. The process waits until a learning model is designated (NO in the step S39), and the process proceeds to the step S40 if a learning model is designated. In a case in which the user operates the operation unit 155 to designate a learning model stored in the storage device 154, it is determined that a learning model is designated.

In the step S40, the CPU 151 imports the designated learning model, and the process returns the learning model generation process. The CPU 151 executes a process of setting a learning model to being subjectable to machine learning, so that the learning model is imported. For example, the process is a process of setting a position and a file name in the storage device 154 in which the designated learning model is stored.

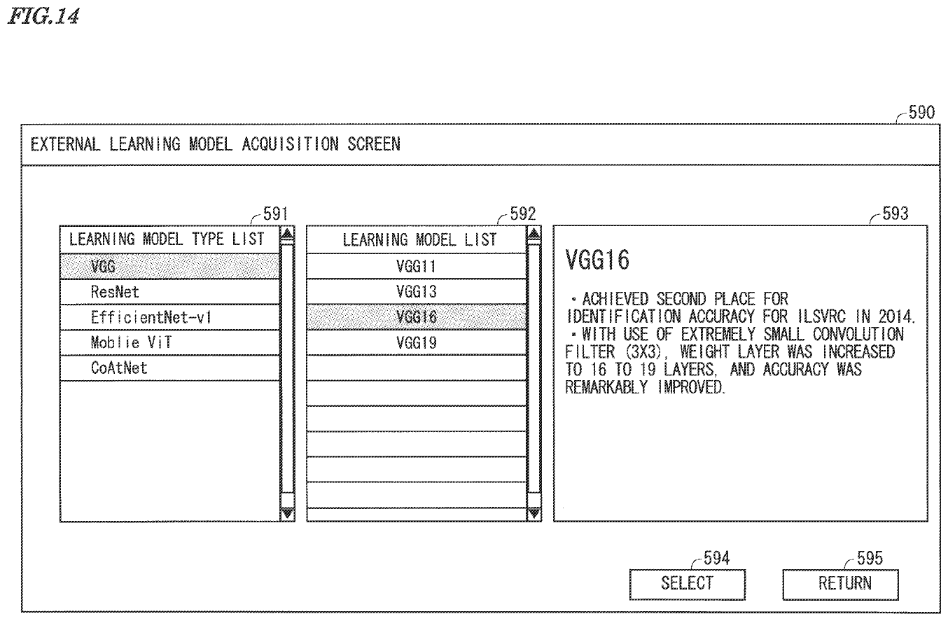

FIG. 14 is a diagram showing one example of an external learning model acquisition screen. The external learning model acquisition screen is a screen displayed on the display device 156 in the step S34 of the learning model acquisition process. With reference to FIG. 14, the external learning model acquisition screen 590 includes an area 591 in which a URL is displayed, an area 592 in which a list of learning models is displayed, an area 593 in which explanatory information is displayed, a button 594 in which the character string “SELECT” is displayed and a button 595 in which the character string “RETURN” is displayed. In the area 591, a list of URLs of library areas for timm or Pytorch Hub is displayed. Here, VGG is selected for a URL of a library area, by way of example.

In the area 592, model identification information pieces of one or more learning models stored in the library area VGG specified by the URL selected in the area 591 are displayed. Here, the model identification information pieces VGG11, VGG13, VGG16 and VGG19 are arranged side by side. Further, the model identification information piece VGG16 is highlighted, and it indicates that the model identification information piece VGG16 is being selected.

The area 593 is an explanatory screen, and displays explanatory information of the model identification information piece VGG16 selected in the area 592. The explanatory information includes detailed information including information representing the characteristics of the learning model specified by the model identification information piece VGG16.

In a case in which the user designates the button 594 with one learning model selected in the area 592, the selected learning model is selected as being subjected to machine learning. In a case in which the user designates the button 595 with one learning model selected in the area 592, the external learning model acquisition screen is switched to another screen with a learning model being subjected to machine learning not selected.

In the external learning model acquisition screen 590, a learning model may be designated with use of another application program and with the user not designating a URL or training. The CPU 151 accesses an URL by executing another application program, and displays a list of model identification information pieces of learning models, for example. An operation of dragging a model identification information piece and dropping the model identification information piece on the external learning model acquisition screen by the user is received. In this case, the CPU 151 displays the model identification information piece of a learning model in the area 592, the learning model having the model identification information piece dropped in the external learning model acquisition screen 590, and displays the URL of the library area in which the learning model is stored in the area 591.

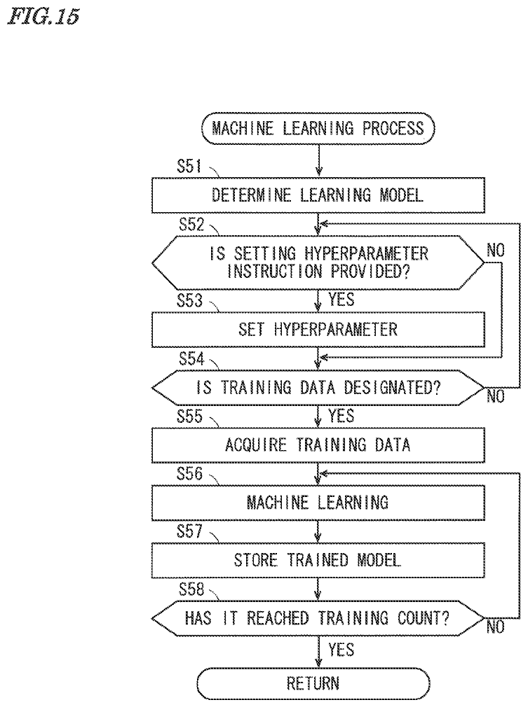

FIG. 15 is a flowchart showing one example of a flow of a machine learning process. The machine learning process is a process executed in the step S05 of the learning model generation process. With reference to FIG. 15, the CPU 151 selects a learning model subjected to machine learning (step S51), and the process proceeds to the step S52. For example, in a case in which the button 594 is designated by the user with one learning model selected in the area 592 of the external learning model acquisition screen shown in FIG. 14, the learning model selected in the area 592 is determined to be subjected to machine learning.

In the step S52, whether a hyperparameter setting instruction is received is determined. If the hyperparameter setting instruction is received, the process proceeds to the step S53. If not, the process proceeds to the step S54. A hyperparameter is set in the step S53, and the process proceeds to the step S54. In the step S54, whether a training data piece is designated is determined. If the training data is designated, the process proceeds to the step S55. If not, the process returns to the step S52. In the step S55, the training data piece is acquired, and the process proceeds to the step S56. Either of the steps S53 and S55 may be performed first.

Machine learning is performed in the step S56, and the process proceeds to the step S57. The CPU 151 subjects a learning model determined to be subjected to a process in the step S51 to machine learning such that the learning model learns the training data piece designated in the step S54 in accordance with the hyperparameter set in the step S53. The machine learning in the step S56 is a process of learning the training data piece designated in the step S54. A unit of training a learning model with a training data piece is an epoch. Therefore, a trained model generated by machine learning is specified by an epoch repetition count. The number of times the step S56 is performed is equivalent to the number of times an epoch is repeated.

The trained model is stored in the storage device 154 in the step S57, and the process proceeds to the step S58. The trained model is stored in the storage device 154 in association with an epoch repetition count. In the step S58, whether the epoch repetition count has reached a training count is determined. A training count is a value set as part of the hyperparameter set in the step S53. If the epoch repetition count has reached the training count, the process returns to the learning model generation process. If not, the process returns to the step S56.

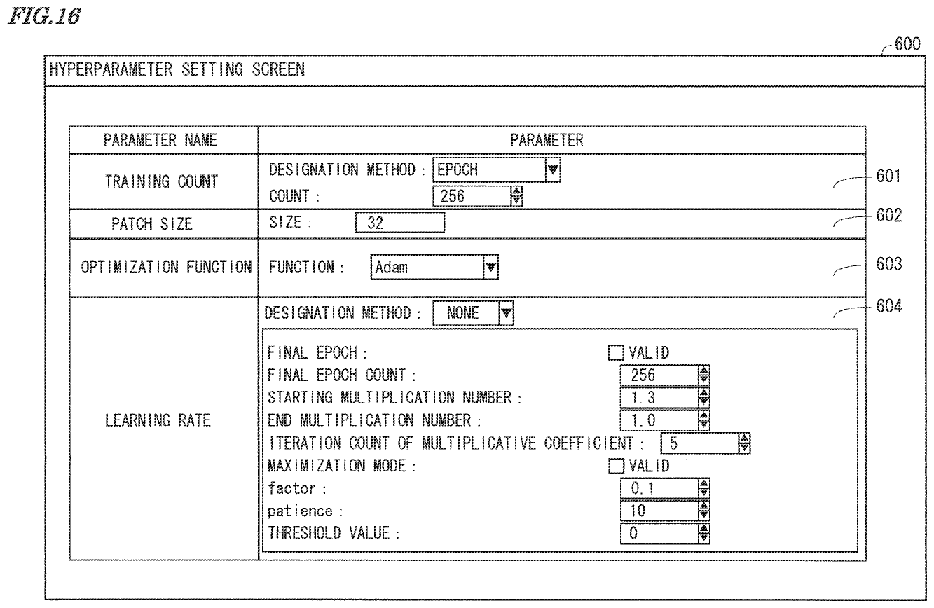

FIG. 16 is a diagram showing one example of a hyperparameter setting screen. The hyperparameter setting screen is a screen displayed on the display device 156 in the step S53 of the machine learning process shown in FIG. 15. With reference to FIG. 16, the hyperparameter setting screen 600 includes areas 601 to 604 for receiving settings of four types of hyperparameters. The area 601 is an area for receiving the setting of a hyperparameter the parameter name of which is a training count. The training count is an upper limit value of the epoch repetition count. The area 602 is an area for receiving the setting of a hyperparameter the parameter name of which is a patch size. A patch size is a value that defines the maximum value of a training data piece to be learned by a learning model in one go during machine learning.

The area 603 is an area for receiving the setting of a hyperparameter the parameter name of which is an optimization function. An optimization function is set by selection from a plurality of functions prepared in advance. The area 604 is an area for receiving the setting of a hyperparameter the parameter name of which is a learning rate. A plurality of parameters for defining a learning rate are prepared, and each parameter can be set.

In regard to a hyperparameter, an initial value is defined in advance as a default value. An initial value is stored in the storage device 154. When the hyperparameter setting screen 600 is displayed, initial values are displayed in the areas 601 to 604. The user can change a hyperparameter by changing an initial value, and can subject one learning model to a plurality of types of machine learning.

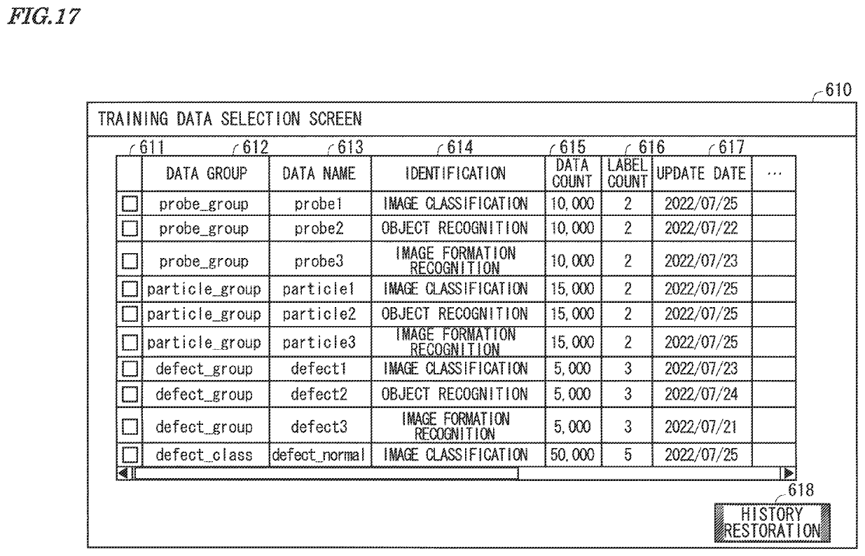

FIG. 17 is a diagram showing one example of a training data selection screen. The training data selection screen is a screen displayed on the display device 156 in the step S55 of the machine learning process shown in FIG. 15. With reference to FIG. 17, the training data selection screen 610 is a screen for displaying a training data table including training data records indicating training data pieces. In the example shown in FIG. 17, the training data table includes ten training data records. A training data record includes an item 611 for a check box, an item 612 for a data group, an item 613 for a data name, an item 614 for identification, an item 615 for a data count, an item 616 for a label count and an item 617 for an update date.

In the item 513 for a data name, a file name for identifying a training data piece is set. In the item 612 for a data group, a group name for identifying a group to which a training data piece belongs is set. In the item 514 for identification, information for identifying an image type information piece of metadata attached to a training data piece is set. In the item for a data count, the number of image data pieces included in a training data piece is set. In the item for a label count, the number of values set in a label information piece of metadata attached to a training data piece is set. In the item 617 for an update date, the date on which a training data is last updated is set.

In a case in which the operation unit 155 receives an operation of selecting one of training data records, a mark is displayed in the item 611 of a checkbox of the training record selected by the user. Therefore, the user can confirm that the training data record is selected.

Further, in the training data selection screen 610, a plurality of training data records can be selected. In this case, a set of training data pieces respectively specified by a plurality of training data records is used as one training data piece for machine learning.

The training data selection screen 610 further includes a button 618 in which a character string “history restoration” is displayed. In a case in which the button 618 is designated by the user, the CPU 151 restores an operation that was input when the user selected a training data piece in the past. Thus, the user can easily select the same training data piece as a training data piece selected in the past.

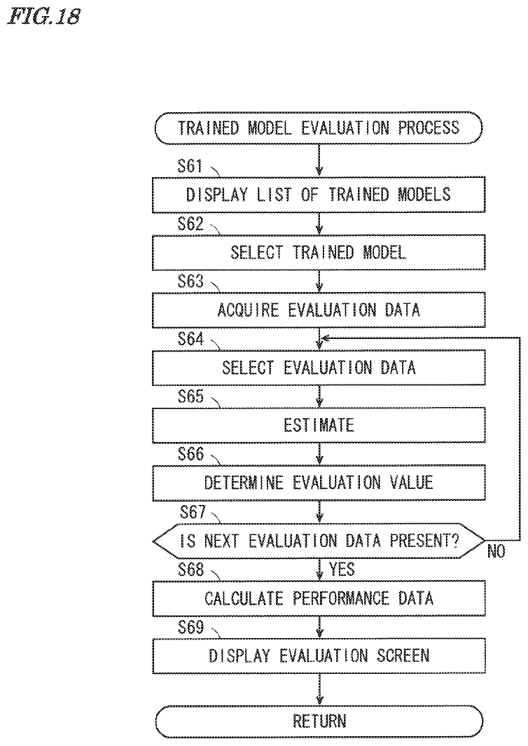

FIG. 18 is a flowchart showing one example of a flow of a trained model evaluation process. The trained model evaluation process is a process executed in the step S06 of the learning model generation process. With reference to FIG. 18, the CPU 151 displays a list of trained models on the display device 156 (step S61), and the process proceeds to the step S62. When the machine learning process shown in FIG. 15 is executed, a trained model for each epoch repetition count N is stored in the storage device 154. In the step S61, a list of model identification information pieces of the trained models stored in the storage device 154 is displayed on the display device 156.

In the step S62, a trained model to be evaluated is selected, and the process proceeds to the step S63. Because the storage device 154 stores a plurality of trained models with different epoch repetition counts, a plurality of trained models having different epoch repetition counts are read from the storage device 154 in regard to a selected trained model.

In the step S63, an evaluation data piece is acquired, and the process proceeds to the step S64. An evaluation data piece is generated at the same time as a training data piece, and has the same format as the training data piece.

In the step S64, one evaluation data piece to be processed is selected, and the process proceeds to the step S65. In the step S65, the CPU 151 causes the trained model to estimate a value, and the process proceeds to the step S66. The CPU 151 inputs an evaluation data piece to each of the plurality of trained models having different epoch repetition counts read from the storage device 154 in the step S62, and acquires an estimated value estimated by each of the plurality of trained models.

An evaluation value is determined in the step S66, and the process proceeds to the step S67. An estimated value is compared with a label information piece included in the evaluation data piece, and an evaluation value indicating whether the estimated value and the label information piece match is determined. An evaluation value is determined in regard to each of a plurality of trained models having different epoch repetition counts. In the step S67, whether an evaluation data piece that is not selected to be processed in the step S64 is present is determined. If an unselected evaluation data piece is present, the process returns to the step S64. If not, the process proceeds to the step S68.

In a case in which the process proceeds to the step S68, evaluation values the number of which is equal to the number of evaluation data pieces are determined in regard to each of the plurality of trained models having the different epoch repetition counts N. In the step S68, a performance data piece is calculated, and the process proceeds to the step S69. A performance data piece includes accuracy, recall and precision as evaluation indices, for example. A performance data piece is calculated for each of a plurality of trained models having different epoch repetition counts. In the step S69, the trained model evaluation screen is displayed, and the process returns to the learning model generation process. The user can select one of a plurality of trained models having different epoch repetition counts with reference to the trained model evaluation screen.

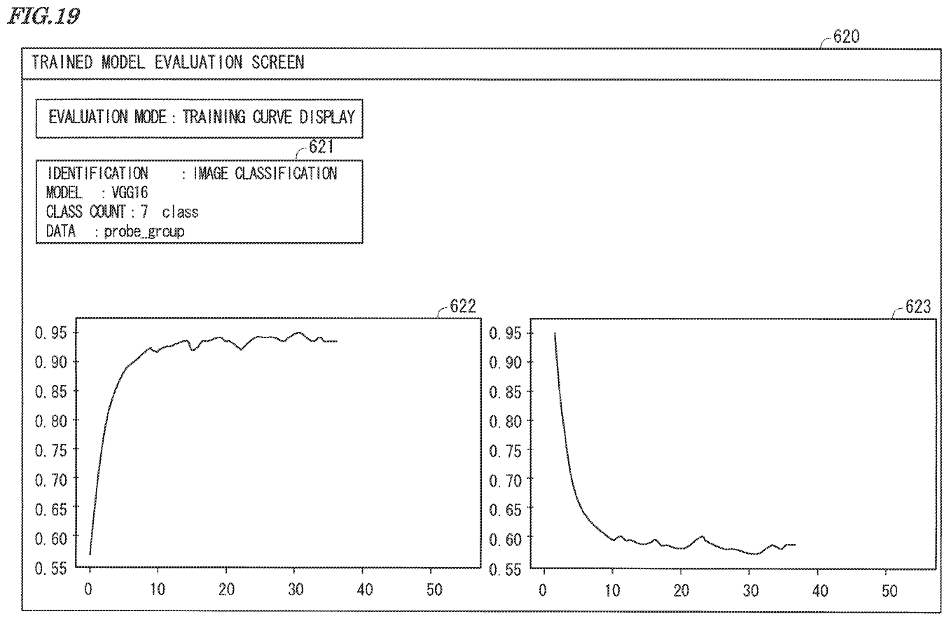

FIG. 19 is a diagram showing one example of a trained model evaluation screen. With reference to FIG. 19, the trained model evaluation screen 620 includes areas 621 to 623. In the area 621, information in regard to a trained model to be evaluated is displayed. Here, in the area 621, it is indicated that the trained model corresponding to the model identification information piece VGG16 is to be evaluated. Further, it is indicated that the trained model has been subjected to machine learning with use of a training data piece of a data group “prob_group.”

A learning curve of the trained model to be evaluated is shown in the area 622. A learning curve is a learning curve with accuracy as an evaluation index. The abscissa represents an epoch repetition count, and the ordinate represents accuracy. A learning curve of a loss of the trained model to be evaluated is shown in the area 623. The abscissa represents an epoch repetition count, and the ordinate represents a loss. A loss is a value of an objective function, and is a value indicating a difference between a correct value of a training data piece and an estimated value of the trained model.

It is shown that, as the epoch repetition count increases, the machine learning by a learning model proceeds, the learning model is adjusted to fit a training data piece, and accuracy is improved. Further, when the epoch repetition count exceeds a predetermined count, accuracy falls in a predetermined range. As the epoch repetition count further increases, accuracy may be degraded, and it can be determined as over-training based on this change in accuracy.

Because being able to view a result of evaluation of a trained model with an evaluation data piece, the user who views the trained model evaluation screen can select a trained model having an appropriate epoch repetition count. Further, it is possible to easily determine whether the trained model is over-trained.

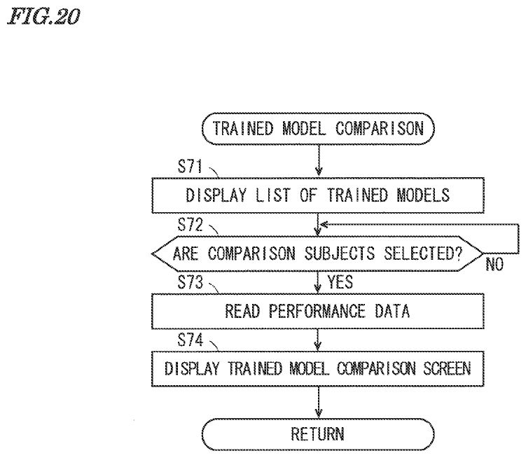

FIG. 20 is a flowchart showing one example of a flow of a trained model comparison process. The trained model comparison process is a process executed in the step S07 of the learning model generation process. With reference to FIG. 20, the CPU 151 displays a list of trained models on the display device 156 (step S71), and the process proceeds to the step S72. When the trained model evaluation process shown in FIG. 18 is executed, one trained model determined from among a plurality of trained models having different epoch repetition counts is stored in the storage device 154. In the step S71, a list of model identification information pieces of a plurality of trained models stored in the storage device 154 is displayed on the display device 156. The plurality of trained models have at least one of different learning models, different hyperparameters and different training data pieces.

In the step S72, whether two or more trained models to be compared are selected is determined. The process waits until two or more trained models are selected (NO in the step S72). When two or more trained models are selected (YES in the step S72), the process proceeds to the step S73.

Performance data pieces are read in the step S73, and the process proceeds to the step S74. Performance data pieces respectively corresponding to two or more trained models are read from the storage device 154. Further, in the step S74, the learning model comparison screen is displayed on the display device 156, and the process returns to the learning model generation process.

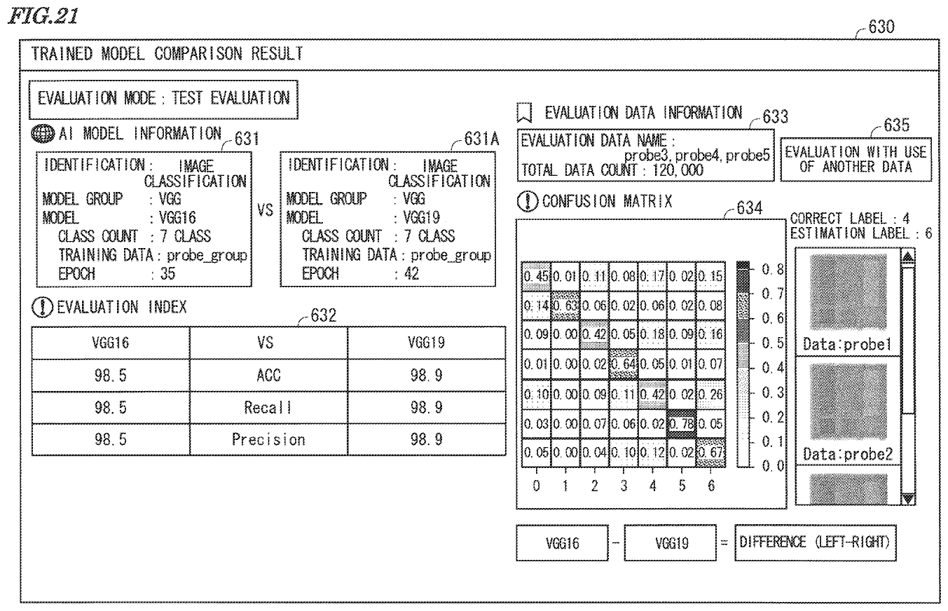

FIG. 21 is a diagram showing one example of a trained model comparison screen. FIG. 21 shows one example of a screen to be displayed in a case in which a trained model corresponding to the model identification information piece VGG16 and a trained model corresponding to the model identification information piece VGG19 are designated. With reference to FIG. 21, the trained model comparison screen 630 includes areas 631, 631A in which information in regard to the trained models to be compared is displayed, and an area 632 in which performance data is displayed. In the area 631, the information in regard to the trained model corresponding to the model identification information piece VGG16 is displayed. In the area 631A, the information in regard to the trained model corresponding to the model identification information piece VGG19 is displayed. In the area 532, performance data of each of the trained model corresponding to the model identification information piece VGG16 and the trained model corresponding to the model identification information piece VGG19 is displayed. “ACC” indicates accuracy, “Recall” indicates recall and “Precision” indicates precision.

The trained model comparison screen 630 further includes areas 633, 634 and a button 635. A confusion matrix is displayed in the area 634. In the area 633, information in regard to an evaluation data piece is displayed. Comparison between the trained model corresponding to the model identification information piece VGG16 and the trained model corresponding to the model identification information piece VGG19 with use of the same evaluation data piece is shown.

Therefore, because the user can compare the performance data pieces of the two trained models, it is possible to easily determine whether which trained model is appropriate. Further, in a case in which the button 635 is designated, the CPU 151 displays a screen for selecting an evaluation data piece on the display device 156, generates a new trained model comparison screen based on the performance data obtained as a result of evaluation of the two trained models with use of a different evaluation data piece selected by the user, and displays the new trained model comparison screen on the display device 156.

Therefore, the user can easily determine which trained model is appropriate by viewing the result of evaluation of the two trained models with use of different evaluation data pieces.

### (3) Effects of Embodiments

With the learning model generation device 100 of the above-mentioned embodiment, because a plurality of existing learning models released on the Internet are displayed on the display device 156 in a selectable manner, selection of a learning model to be subjected to machine learning is facilitated. Because the existing learning model is subjected to machine learning, it is not necessary to create a learning model by coding. In particular, on the external learning model acquisition screen 590 shown in FIG. 14, explanatory information is displayed in the area 593. Although the algorithms of the plurality of existing learning models are diversified, the user can know the algorithms of the learning models by viewing the explanatory information displayed in the area 593, and can easily select a learning model suitable for the purpose of estimation from among the plurality of existing learning models.

Further, the plurality of existing learning models released on the Internet are stored in a library area of timm or Pytorch Hub. Because the plurality of learning models stored in these library areas have the same interface, it is not necessary to convert a training data piece in accordance with the learning models. Therefore, it is possible to subject a learning model to machine learning without creating a program for adapting a training data piece to the learning model. As a result, it is possible to provide the learning model generation device 100 capable of easily generating a trained learning model.

Further, because the GUI for generating a training data piece is displayed on the display device 156, the user can easily generate a training data piece based on an image data piece.

Further, an operation screen (the data augmentation setting screen 540 of FIG. 8) for receiving an instruction from the user for generation (augmentation) of another new image data piece based on an image data piece is displayed. Thus, the user may input an instruction for generating a new image data piece in accordance with the operation screen, and can easily generate a new image data piece.

Further, because the operation screen (the image classification setting screen 550 of FIG. 9, the object recognition setting screen of FIG. 10 and the area classification setting screen of FIG. 11) for receiving metadata to be added to an image data piece is displayed, the user may designate the metadata to be added to the image data piece in accordance with the operation screen, and an operation for annotation is facilitated. Therefore, it is possible to easily generate a training data piece without coding a program for generating a training data piece.

Further, because the GUI (the hyperparameter setting screen 600) for setting a hyperparameter is displayed on the display device 156, the user can easily set a hyperparameter before machine learning. Further, with a hyperparameter set by the user being set in a learning model selected by the user, a learning model is subjected to machine learning. Therefore, because it is not necessary to code a program for setting a hyperparameter in a learning model, a hyperparameter can be easily set in a learning model.

The learning model generation device 100 according to the present embodiment does not need to code a program in any of the stage of generation of a learning model, the stage of setting of a hyperparameter and the stage of generation of a training data piece. Therefore, even a person who does not have knowledge about a program can subject a learning model to machine learning and generate a trained learning model. Further, the learning model generation device 100 can generate a trained model in a short period of time compared to a case in which a program is to be created.

### (4) Overview of Embodiments

(Item 1) A learning model generation device according to one aspect of the present disclosure includes a model information display that displays a plurality of learning models being released on Internet and having a same interface in a selectable manner, a model selector that displays at least one learning model among the plurality of displayed learning models, and a trainer that subjects the selected learning model to machine learning such that the selected learning model learns training data, and generates a trained model that has been trained.

According to this aspect, because a plurality of existing learning models released on the Internet are displayed in a selectable manner, it is easy to select a learning model to be subjected to machine learning. Further, because the plurality of learning models displayed in a selectable manner have the same interface, it is not necessary to match a learning model with training data. Thus, it is possible to subject a learning model to machine learning without creating a program. As a result, it is possible to provide the learning model generation device capable of easily generating a trained learning model.

(Item 2) The learning model generation device according to item 1 may further include an image data acquirer that acquires image data, and a training data generator that generates training data based on the image data acquired by the image data acquirer, wherein the training data generator may have a graphical user interface for generating training data.

According to this aspect, because a graphical user interface for generating training data is provided, the user can easily generate training data based on image data.

(Item 3) The learning model generation device according to item 2, wherein the graphical user interface may have an operation screen for receiving an instruction for generating another new image data based on the image data.

According to this aspect, because the operation screen for receiving an instruction from the user for generating another new image data based on image data is displayed, the user may input an instruction for generating the new image data in accordance with the operation screen, and the new image data can be easily generated.

(Item 4) The learning model generation device according to item 2 or 3, wherein the graphical user interface may have an operation screen for receiving information to be added to the image data.

According to this aspect, because the operation screen for receiving information to be added to image data is displayed, the user may designate information to be added to the image data in accordance with the operation screen, and training data can be easily generated.

(Item 5) The learning model generation device according to items 1 to 4, wherein the model information display may further display information in regard to characteristics of the plurality of learning models.

According to this aspect, because information in regard to the characteristics of a learning model is displayed, when the user selects one of the plurality of learning models to be subjected to machine learning, the user can be assisted.

(Item 6) The learning model generation device according to items 1 to 5, may further include a parameter setter that sets a hyperparameter that is used when the trainer subjects the learning model to machine learning, wherein the parameter setter may have a graphical user interface for setting a hyperparameter.

According to this aspect, because the graphical user interface for setting a hyperparameter is provided, the user can easily set a hyperparameter.

(Item 7) The learning model generation device according to items 1 to 6, wherein the model selector may be configured to select a custom model which is prepared in advance separately from the plurality of learning models released on the Internet, and the custom model may have a same interface as that of the plurality of learning models released on the Internet.

According to this aspect, the user can easily subject a custom model different from the plurality of learning models released on the Internet to machine learning.

(Item 8) The learning model generation device according to items 1 to 7, may further include an evaluation data acquirer that acquires evaluation data, an evaluator that evaluates the trained model generated by the trainer with use of the evaluation data, and an evaluation result display that displays an evaluation result in regard to the trained model.

According to this aspect, the evaluation data is acquired, the trained model that has been subjected to machine learning to learn training data is evaluated with use of the evaluation data, and an evaluation result is displayed. Therefore, it is possible to provide the user with information in regard to the machine learning by the learning model including selection of the learning model.

(Item 9) The learning model generation device according to item 8, wherein in a case in which there are the plurality of trained models, the evaluation result display may display a plurality of evaluation results respectively corresponding to the plurality of trained models side by side.

According to this aspect, because the plurality of evaluation results respectively corresponding to the plurality of trained models are displayed side by side, the user can easily compare the plurality of trained models.

(Item 10) A learning model generation method according to another aspect that causes a computer to execute a model information display step of displaying a plurality of learning models being released on Internet and having a same interface in a selectable manner, a model selecting step of displaying at least one learning model among the plurality of displayed learning models, and a training step of subjecting the selected learning model to machine learning such that the selected learning model learns training data, and generating a trained model that has been trained.

According to this aspect, it is possible to provide the learning model generation method with which a trained learning model can be easily generated.

(Item 11) A non-transitory computer readable medium storing a learning model generation program according to yet another aspect of the present disclosure causes a computer to execute a model information display step of displaying a plurality of learning models being released on Internet and having a same interface in a selectable manner, a model selecting step of displaying at least one learning model among the plurality of displayed learning models, and a training step of subjecting the selected learning model to machine learning such that the selected learning model learns training data, and generating a trained model that has been trained.

According to this aspect, it is possible to provide a non-transitory computer-readable medium storing a learning model generation program capable of easily generating a trained learning model.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/We claim:

1. A learning model generation device comprising:
a model information display that displays a plurality of learning models being released on Internet and having a same interface in a selectable manner;
a model selector that displays at least one learning model among the plurality of displayed learning models; and
a trainer that subjects the selected learning model to machine learning such that the selected learning model learns training data, and generates a trained model that has been trained.

2. The learning model generation device according to claim 1, further comprising:
an image data acquirer that acquires image data; and
a training data generator that generates training data based on the image data acquired by the image data acquirer, wherein
the training data generator has a graphical user interface for generating training data.

3. The learning model generation device according to claim 2, wherein
the graphical user interface has an operation screen for receiving an instruction for generating another new image data based on the image data.

4. The learning model generation device according to claim 2, wherein
the graphical user interface has an operation screen for receiving information to be added to the image data.

5. The learning model generation device according to claim 1, wherein
the model information display further displays information in regard to characteristics of the plurality of learning models.

6. The learning model generation device according to claim 1, further comprising a parameter setter that sets a hyperparameter that is used when the trainer subjects the learning model to machine learning, wherein
the parameter setter has a graphical user interface for setting a hyperparameter.

7. The learning model generation device according to claim 1, wherein
the model selector is configured to select a custom model which is prepared in advance separately from the plurality of learning models released on the Internet, and
the custom model has a same interface as that of the plurality of learning models released on the Internet.

8. The learning model generation device according to claim 1, further comprising:
an evaluation data acquirer that acquires evaluation data;
an evaluator that evaluates the trained model generated by the trainer with use of the evaluation data; and
an evaluation result display that displays an evaluation result in regard to the trained model.

9. The learning model generation device according to claim 8, wherein
in a case in which there are the plurality of trained models, the evaluation result display displays a plurality of evaluation results respectively corresponding to the plurality of trained models side by side.

10. A learning model generation method for causing a computer to execute:
a model information display step of displaying a plurality of learning models being released on Internet and having a same interface in a selectable manner;
a model selecting step of displaying at least one learning model among the plurality of displayed learning models; and
a training step of subjecting the selected learning model to machine learning such that the selected learning model learns training data, and generating a trained model that has been trained.

11. A non-transitory computer readable medium storing a learning model generation program that causes a computer to execute:
a model information display step of displaying a plurality of learning models being released on Internet and having a same interface in a selectable manner;
a model selecting step of displaying at least one learning model among the plurality of displayed learning models; and
a training step of subjecting the selected learning model to machine learning such that the selected learning model learns training data, and generating a trained model that has been trained.
